(19) United States
(12) Patent Application Publication
(10) Pub. No.: US 2003/0090818 A1
(43) Pub. Date: May 15, 2003

(54) Co-aligned receiver and transmitter for wireless link

(76) Inventor: John Carl Wittenberger, Barrington, RI (US)

Correspondence Address: Dennis Moore, Texas Instruments Incorporated, M/S 3999, P.O. BOX 655474, Dallas, TX, 75265, US

(21) Appl. No.: 10/007,776

(22) Filed: Nov. 2, 2001

(51) Int. Cl. H04B 10/00; G02B 5/08

(52) U.S. Cl. 359/838

(57) ABSTRACT

The present invention provides advantages as an optical wireless system (200) that in one embodiment provides a micromirror (250) between a transmitter (210) and a receiver (220) to obtain high speed optical wireless communication for both indoor and outdoor use. The micromirror advantageously aligns the transmitter laser beam to the receiver during vibration thereof. The invention also provides a method of using the same.

### TECHNICAL FIELD

Generally, the invention relates to optics, and more particularly to high-speed optical wireless links.

### STATEMENT OF A PROBLEM ADDRESSED BY THIS INVENTION

Performance of an Optical Wireless Link (OWL) is established by the system design. For a specified data rate and bit error rate, there is a minimum power requirement on the receiver data detector. With that minimum power and a particular receiver optics design, there is minimum beam intensity (power per area) that incident upon the receiver. For that incident intensity, the maximum operating distance and beam divergence, there is a minimum power that the transmitter must emit.

Performance of an Optical Wireless Link (OWL) is impeded by variety of physical limitations. One physical limitation is that of vibration. This is because vibration produces both transitional and rotational movement of the receiver and transmitter. If the vibrational rotation is larger than the transmitter beam divergence, or the receiver field of view, then the data flow between the transmitter and receiver will be lost. That is, if the transmitter's beam vibrates off the receiver, then it cannot send power to the receiver. In addition, if the receiver turns and cannot see the transmitter, then it cannot collect power from the transmitter even though the transmitter's beam is on the receiver.

The first traditional solution to vibration problems is to make everything rugged and stiff. However, this means that the pole, wall or building on which are mounted is the source of vibration and cannot be controlled.

For the transmitter, the traditional solutions to the vibration problem are to increase the divergence (beam size) so that the divergence is larger than the rotational vibration. However, given a fixed power, the beam intensity is inversely proportional to the divergence squared and also inversely proportional to the distance squared. Thus, if the divergence is doubled, the maximum working distance must be reduced to one half (or the beam emitted power increased by a factor of four).

For the receiver, the traditional solution to the vibration problem is to increase the field of view so that the field of view is wider than the rotational vibration. The field of view is the angle across which a beam can be detected by the receiver. This is determined by the data detector's radius and the data optic's focal length. Reducing the focal length of the data optics is not usually done as this also decreases the diameter of the data optics and the amount of power that the data detector receives. Instead, the radius of the data detector is increased. However, capacitance of the data detector is proportional to its area or proportional to the radius squared. The response time of the data detector is inversely proportional to the capacitance. Thus, by increasing the field of view, that data rate (high speed) of the receiver is limited.

A further problem with increasing the receiver's field of view is that the receiver is sensitive to all sources of light within its field of view. These sources may be sunlight, artificial lighting or another transmitter. These extraneous sources can increase the bit error rate. Accordingly, to overcome these and other disadvantages associated with existing methods of transmitting data optically, it would be advantageous to provide devices and systems that transmit optical data while minimizing interference from physical limitations.

### SELECTED OVERVIEW OF SELECTED EMBODIMENTS

The present invention provides technical advantages as a co-aligned receiver and transmitter for an optical wireless link, and as methods for using the same. The invention can be implemented by using a separate micromirror for the receiver and transmitter, or by aligning the optical axis of the receiver and transmitter and using one micromirror. Outdoor applications include Fiber to Curb and Last Mile applications, for example. The present preferred Optical Wireless Link (OWL) design uses a 1 mm-diameter receiver. This receiver size allows the receiver to collect energy anywhere within ±5° field of view.

In another embodiment, the invention is a system of arranging optical equipment. The system includes a transmitter, a receiver, and a beam splitter located between the receiver and transmitter. The system also includes a lens for receiving a beam reflected off a micromirror. In this and in other embodiments, the invention is a system of arranging optical elements. The system includes a micromirrors, lenses, beamsplitters, light sources and detectors.

Of course, other features and embodiments of the invention will be apparent to those of ordinary skill in the art. After reading the specifications, and the detailed description of the exemplary embodiment, those persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates two ports, each having a transmitter and a receiver;

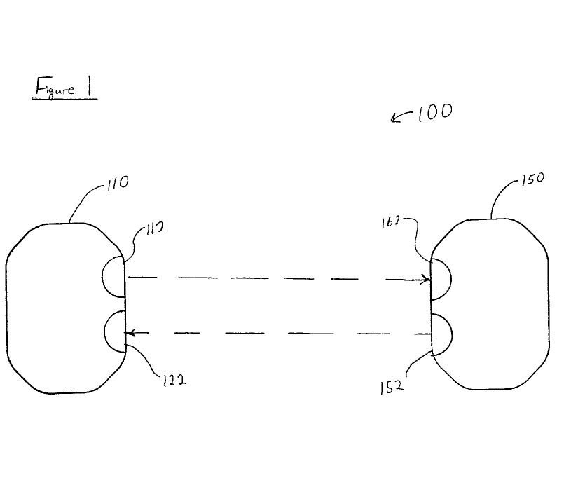

FIG. 2 is an arrangement of optical equipment according to the teachings of the invention;

FIG. 3 is yet another embodiment of optical equipment for an optical wireless link, primarily for outdoor use; and

FIG. 4 illustrates two micromirrors used to reflect a beam.

### AN EXEMPLARY EMBODIMENT OF A BEST MODE

The invention uses a micromirror on both a transmitter and a receiver to obtain high speed optical wireless communication for both indoor and outdoor use. The invention can also be implemented by using a separate micromirror for the receiver and transmitter, or by aligning the optical axis of the receiver and transmitter and using one micromirror. This receiver size allows the receiver to collect energy anywhere within ±5° field of view, thus increasing the transfer rate and reliability of an Optical Wireless Link (OWL or OWLink).

One OWLink is implemented as a transmitter and a receiver placed together in a first communication port (port A), and a transmitter and a receiver placed together in a second communication port (port B). Two communication ports are aimed at each other to establish full duplex communication between them (port A and port B). Accordingly, each port comprises a transmitter and a receiver.

The transmitter emits a light beam that does not “spread out”—in other words, the transmitter produces a small divergence light beam. Small divergence of the light beam is typically obtained by collimating a light source (VCSEL) with a lens (typically to a divergence of ±0.03°). The size (diameter) of the beam on a receiver is proportional to first, the distance that the receiver is from the transmitter, and second, to the divergence of the beam. The intensity of the spot (energy per area) on the receiver is proportional to the spot area or is proportional to the distance squared and to the divergence squared. The advantage of having a low divergence beam is the energy remains concentrated, and thus a great distance between the transmitter and receiver can be achieved. It should be noted that “light” in this description is typically about inferred radiation, at 850 mm.

The transmitter beam is preferably steered. Accordingly, the beam may strike a micromirror, and the micromirror can then deflect the beam in two angular axes. As the transmitter vibrates, it moves both in translation and in rotation; and the micromirror is adjusted to keep the beam aimed at the receiver.

The receiver accepts light from a wide angle (±5°), field of view. Accordingly, the receiver has a data lens to collect a large amount of light, and a data detector to convert the light to electricity. The field of view is determined by the data detector's radius (0.5 mm) divided by the data lens focal length (5 mm). During vibration, the rotational component of the receiver's vibration is within the receiver's field of view.

Additionally, the receiver typically has a data lens surrounded by servo sensors. Usually, the receiver has four servo sensors surrounding the data lens. Each servo sensor consists of a servo lens and a servo detector. When the transmitter beam from a port B is centered on the data lens of the receiver in a port A, the same amount of light is collected by the four servo lenses. As a transmitter beam moves away from the center of a data lens, the light collected by the four servo lenses is no longer equal, and that information can be used to determine which way the beam has moved. Thus, the receiver in port A can send this information back to the transmitter in port B, and the transmitter in port B can adjust the aim of the micromirror to return the beam to the center of the port A receiver's data lens. During vibrations of the receiver in port A, the servo sensors sense the receiver's transitional movement. Accordingly, port A sends that information to port B. Then port B's transmitter beam is moved to keep itself centered on port A's data lens.

The OWLink 100 of the invention uses two ports (port A 110, and port B 150), with a transmitter 112, 152, and a receiver 122, 162 placed together in each communication port 110, 150. The OWLink 100 aims the communication ports 110, 150 at each other to establish full duplex communication. Accordingly, each port 110, 150 comprises a transmitter and a receiver. However, the OWLink 100 of the invention has several unique attributes.

In a preferred embodiment of the invention, the receiver 122, 162 in each port has a field of view that is approximately the same as that of the transmitter that transmits to the receiver (preferably about +/−1 degree or less). This means that for a receiver to obtain any signal from a transmitter, its axis (center of the field of view) must be approximately directly aimed at the transmitter. The focal length of a data lens of a receiver data lens is similar to the transmitter collimating lens, and the radius of the data detector is much smaller. Thus, the smaller data detector has much less capacitance, enabling a faster response. In addition, each receiver axis is steered. Preferably, a micromirror is placed along each of the receiver's axis in a manner that the axis is reflected off the micromirror.

Preferably, each receiver axis is aligned to a corresponding transmitter beam axis. One preferred implementation is using one micromirror for both the transmitter and receiver. In this configuration, the axis of the transmitter and receiver are the same (or, in other words, are co-aligned). In an alternative embodiment, two micromirrors are used. A first micromirror deflects the axis of the transmitter, and a second micromirror deflects the axis of the receiver. The axis of the receiver and the transmitter are approximately aligned to be parallel to each other, and are deflected in a manner that they remain approximately parallel to each other.

Furthermore, the preferred receiver has an entrance to the data lens surrounded by servo sensors. The servo sensors are placed around the data lens if the micromirror is between the data lens and the data detector. Otherwise, servo sensors are placed around the entrance port of the micromirror if the micromirror is in front of the data lens. Servo sensors in port A detect port B's transmitter beam position, and may transmit that information to port B (so that the transmitter beam's location can be corrected). As port B corrects the aim of its (port B's) transmitter beam, it also corrects the aim of its receiver axis, and thus keeps port B's receiver axis aimed at port A's transmitter.

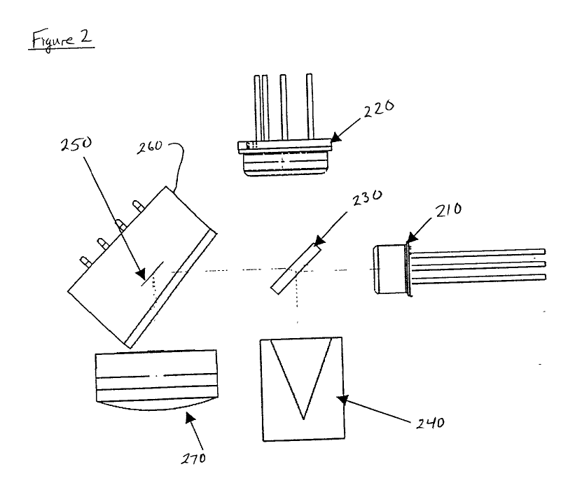

The invention can be characterized as a system of arranging optics. FIG. 2 is an arrangement of optical equipment according to the teachings of the invention. An emitter 210 casts a beam of light to a receiver 220. In one preferred embodiment, the emitter 210 may be a Light Emitting Diode (LED), a Vertical Cavity Surface Emitting Laser (VCSEL), or another type of laser. Similarly, in a preferred embodiment, the receiver 220 is preferably a silicon photodiode. Receiver 220 could also be other types of semiconductor photodiodes such as gallium arsenate semiconductor photodiodes, for example. It should be understood that for long distance operation the receiver 220 needs a large aperture lens thereon to collect an adequate amount of light to decode/demodulate.

The receiver collection angle is defined as the receiver size divided by the collection optics focal length. In conventional applications, the receiver aperture lens can not be much larger than the focal length. In addition, to obtain high-speed operation, the receiver 220 is preferably small. However, typically, the collection angle is relatively large so that as vibration occurs, the rotation of the receiver remains within the collection angle.

Advantageously, to obtain high speed operation according to this invention, the receiver 220 is small and the receiver optical axis (center of collection angle) reflects off a micromirror 250. Specifically, the rotation of the micromirror 250 is servo-locked to the transmitter 210. Thus, as the receiver rotates, the small collection angle is always aimed at the transmitter. The light emitted from the emitter 210 comprises an emitted beam. The emitted beam travels to the receiver through a beam splitter 230 via a first beam. The emitted beam travels to a micromirror and to other optical equipment as a second beam, which also originates at the beam splitter 230. A fourth beam, called a sink beam, propagates to an optical sink from the beam splitter.

The frequency response of the optical network 200 is dependent on receiver capacitance. Likewise, the receiver capacitance is proportional to the receiver size, and the size of the receiver is proportional to the field of view. For the transmitter, the field of view is the angle that the micromirror 250 can deflect the beam without losing transmission data or transmission strength. For the receiver, the field of view can collect light (and is also known as a “Collection Angle”). Advantageously, when arranged according to the teachings of the invention, the frequency response of the owl link can be improved by about a factor of 100 by using a 0.1 mm diameter receiver. However, some arrangements of optical equipment will reduce the field of view to ±1°.

Normally a small (±1°) field of view would create an aiming problem for the receiver. However, by arranging the optics according to the teachings of the invention, both the emitter 210 and receiver 220 are aimed by the same micromirror 250 so that light passing from the emitter 210 is sent to the receiver 220.

Both the emitter 210 and receiver 220 are aimed, and a transmitting beam and receiving beam move together as vibration moves the OWL. This is achieved because in a co-axial approach, both the emitter 210 and receiver 220 have the same optical axis. Thus when the micromirror deflects light, the transmitter beam and the receiver field of view move together.

Functionally, the OWL is a transceiver (which is a transmitter and a receiver). For conventional short range OWLs, the transmitter directs light (typically embodied as infra-red, or IR, radiation) over a wide angle and the receiver receives the light from a wide angle. To obtain the ability to transmit and receive data across a medium range, the transmitter directs the light into a smaller angle (typically, a cone diverging at about ±10°) and the receiver is sensitive to smaller angles. A TV remote-control is typical of a medium range device. To obtain the ability to transmit and receive data across longer distances, the transmitter collimates a beam of light and the receiver can have medium collection angle (of about ±5°).

In a preferred embodiment of the indoor optical wireless link, according to the present invention, the beam is collimated and then reflected off a micromirror which can deflect the beam about both the X and Y axis. The beam is servo locked on the receiver. Thus, when the transmitter s, the servo keeps the beam locked to the receiver.

In addition, the receiver is sensitive to light from ±5° field of view. This combination prevents the receiver from being sensitive to vibrations. However, to be sensitive to this angle, the receiver is preferably relatively large (such as one millimeter in diameter in one embodiment). The capacitance of this receiver is fairly large and limits the data rate to about a one-hundred megabit ether net.

Conventionally, to obtain one gigabit Ethernet transmission, the receiver diameter is reduced, preferably to about 0.2 millimeters in diameter. The receiver has 1/25 of the area and capacitance that the one millimeter diameter receiver has. For the same optics, it has ⅕ the field of view (collection angle). Thus, it would be sensitive to vibration. Advantageously, to reduce or eliminate sensitivity to vibration, the receiver optics are also directed to the micromirror. Thus, the receiver can be aimed and servo-locked to avoid the vibration problems.

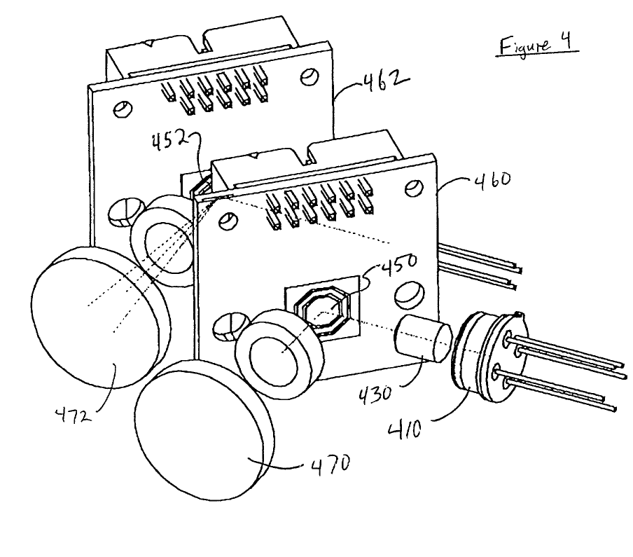

One additional solution to the vibration problem is to use two micromirrors. Accordingly, FIG. 4 illustrates two micromirrors used to reflect a beam. A first emitter 410 casts a beam of light through a beam expander 430 to an optical device lens 470. A first micromirror assembly 460 houses a first micromirror 450, and a second micromirror assembly 462 houses a second micromirror 452. The second micromirror 452 reflects a beam generated by s second emitter (not shown) to a second lens 472. Yet another solution to the vibration problem is to align the transmitter and receiver on ONE optical axis, and then use one micromirror to servo lock both the transmitter and the receiver.

FIG. 2 shows the emitter 210, receiver 220, a micromirror 250 that is preferably a SPAM3 micromirror, a lens 270, the system having a 30 mm EFL (Effective Focal Length). If there is a parallel light entering the lens 270, the EFL is the distance between one of the lens' nodal points to the point which the light comes to a focus. If parallel light enters the lens at an angle to the axis of the lens, it will exit the lens at the same angle to the optical axis and be focused from a plane at the nodal point.

Lens 270 is preferably a 12 mm diameter achromatic lens. An achromatic lens, typically comprises two elements and is designed to correct for chromatic aberrations. It also improves other types of aberrations. The generated beam is preferably 3 mm in diameter, and is size-limited by the micromirror 250 because the micromirror is micromachined on a silicon wafer. The processing of a silicon wafer is expensive and to keep the cost of a micromirror down, many micromirrors need to be on one wafer. This requires that the micromirror is small. The beam reflects off of the micromirror and can not be much larger than the micromirror. However, it is desired that the lens be large enough to not vibrate the beam at ±5° aim.

The distance from a VCSEL transmitter 210 to the micromirror 250 is preferably about 24 mm. With a preferred embodiment's 3 mm-diameter beam, the collection angle is about ±3.6°, which is most of the emission angle.

The micromirror 250 preferably deflects ±3.13° because the micromirror is between the lens and the emitter. Ideally, to achieve long distance operation, the beam would never expand and would be the same size at one mile as the size it was at one foot. However, at least three factors cause the beam to diverge—Geometric Divergence, Aberration Divergence, and Diffraction Divergence. Geometric Divergence is caused by the finite size of the emitter. Geometric Divergence is the emitter's size divided by the collimating lens's EFL. Aberration Divergence is caused by the imperfections in the lens design and manufacturing. Diffraction Aberration is caused by the light diffracting off the edge of the lens aperture. An optical system is diffraction limited when the Geometric and Aberration Divergence is less than the Diffraction Divergence. Diffraction Divergence is less than the Diffraction Divergence. Diffraction Limit is generally considered the best that an optical system can be made.

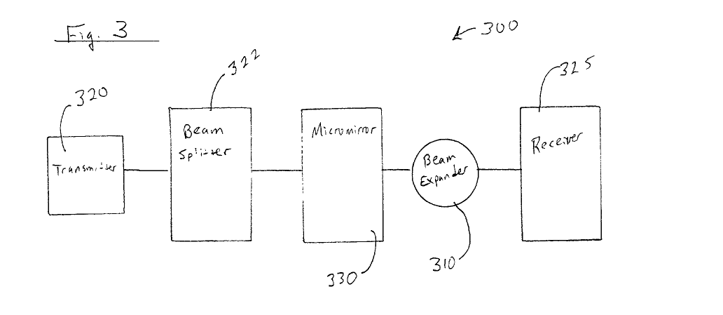

The Diffraction Aberration is reduced as the beam diameter is increased. Thus, for long distances, increasing the beam diameter has an advantage. This can be accomplished by using a beam expander 310 in the optical system 300 as illustrated in FIG. 3, or by increasing the size of a micromirror 330. FIG. 3 is yet another embodiment of the invention, primarily for outdoor use. In the optical system 300, the beam expander is optically coupled between a transmitter 320 and a receiver 325, and preferably between the micromirror 330 and the receiver 325. The beam expander 310 is preferably a Gaussian telescope, having a negative lens that expands the beam and a positive lens that re-collimates the beam. The diffraction limit of a 3 mm aperture is about 0.69° (total). Accordingly, the 30 mm EFL lens matches that divergence. Although the beam expander 310 is preferably located between the micromirror 330 and the receiver 325, the beam expander 310 maybe located in other points along the optical axis in the optical network 300, such as between the micromirror 330 and a beam splitter 322, for example. The actual placement of the beam expander 310 will depend on the particular application and the particular environmental conditions of the optical network 300.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A system of optical equipment in an Optical Wireless Link that transmits data, comprising:
a transmitter that generates a laser;
a receiver;
a beam splitter located between the transmitter and the receiver, wherein the beam splitter is adapted to split the beam of laser light from the transmitter into at least a first receiver beam and a second beam; and
a micromirror enabled to receive the second beam, and enabled to direct the second beam to the receiver.

2. The system of claim 1 further comprising a lens that receives the second beam from the micromirror.

3. The system of claim 2 wherein the receiver has a diameter of about 0.1 mm.

4. The system of claim 3 further comprising a beam expander optically coupled between the micromirror and the receiver.

5. The system of claim 3 further comprising a beam expander optically coupled between the micromirror and the transmitter.

6. The system of claim 3 wherein the micromirror is a SPAM3 micromirror.

7. The system of claim 1 wherein a second micromirror is enabled to receive the second beam, and enabled to direct the second beam to optical equipment.

8. The system of claim 2 wherein the lens is of sufficient size to avoid vibrating the beam of light when the lens is adjusted to a +/−5 degree aim.

9. The system of claim 2 wherein the transmitter comprises a VCSEL optically coupled to the micromirror, wherein the distance of the VCSEL to the micromirror is approximately 24 mm.

10. The system of claim 2 wherein the beam of laser light is approximately a 3 mm-diameter beam.

11. The system of claim 2 wherein the micromirror deflects at approximately +/−3.13 degrees.

12. The system of claim 2 wherein the beam of laser light has a diffraction limit of about 0.69 degrees.

13. The system of claim 3 wherein the micromirror size is a function of the distance of transmission of the beam of laser light from the transmitter to the receiver.

14. The system of claim 1 wherein the emitter and the receiver have the same optical axis.

15. The system of claim 1 wherein a transmitter beam is defined between the transmitter and the beam splitter, and wherein the transmitter beam and a receiver field of view move together.

16. The system of claim 13 wherein the micromirror is enabled to deflect the first beam in either an X and a Y axis.

17. The system of claim 7 wherein the second micromirror is enabled to deflect the second beam in either an X and a Y axis.

18. The system of claim 4 wherein the beam expander is preferably a Gaussian telescope having a negative lens.

19. A method of transmitting data in an optical wireless network, comprising:
transmitting data via a laser from a transmitter having a lens coupled thereto;
splitting the laser into a first beam and a second beam;
receiving the first beam at a receiver having a lens coupled thereto; and
reflecting the second beam to an optical equipment via a micromirror.

20. The method of claim 19 further comprising utilizing a beam expander to couple the first beam between the emitter and the receiver.

21. The method of claim 13 further comprising receiving the second beam at a lens.

22. The method of claim 13 further comprising directing a third beam into a laser sink.
